(19) United States
(12) Patent Application Publication
(10) Pub. No.: US 2021/0216611 A1
(43) Pub. Date: Jul. 15, 2021

(54) DEVICE, METHOD, AND PROGRAM FOR ESTIMATING INTEGRAL NUMBER OF MOVING PEOPLE

(71) Applicant: NIPPON TELEGRAPH AND TELEPHONE CORPORATION, Tokyo (JP)

(72) Inventors: Yasunori AKAGI, Tokyo (JP); Takuya NISHIMURA, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 15/733,886

(22) PCT Filed: May 27, 2019
(86) PCT No.: PCT/JP2019/020949

§ 371 Date: Nov. 30, 2020

(30) Foreign Application Priority Data
Jun. 1, 2018 (JP) 2018-106264

(51) Int. Cl. G06F 17/18

(52) U.S. Cl. CPC G06F 17/18

(57) ABSTRACT

A human migration number can be estimated as an integer value with high accuracy without depending on the size of an area. A human migration number between areas at each time is estimated on the basis of the population of each of the areas at the time under a constraint that the population of each of the areas at each time and a human migration number between the areas at the time are in a predetermined relation and that the human migration number between the areas at the time is an integer value in order to maximize a likelihood function expressed using the population of each of areas at each time, the human migration number between the areas at the time, and the migration probability between the areas, the migration probability between the areas is estimated on the basis of the estimated human migration number between the areas at the time in order to maximize the likelihood function, and the estimation processing is repeated until a predetermined condition is satisfied.

### TECHNICAL FIELD

The present invention relates to an integer human migration number estimating device, a method, and a program, and particularly to an integer human migration number estimating device, a method, and a program for estimating a human migration number between areas at each time.

### BACKGROUND ART

Positional information about people, which is available for example from the GPS, is sometimes provided as demographic information which cannot be used to track individuals for privacy protection. Here, the demographic information is information about the number of people in each area at each time step (time). Areas are assumed to be obtained for example by dividing a geographic space in a grid form. There has been a need for estimating a migration probability and a human migration number between areas between time steps from such demographic information.

According to a conventional technique, a migration probability and a human migration number between areas are estimated using a framework (Collective Graphical Model) for estimating individual probability models from aggregated data (see NPL 1 and NPL 2).

According to the technique, estimation is performed by finding M and θ which maximize a likelihood function L(M, θ) calculated from the number of migrating people Mt_{i j} from an area i to an area j from time t to time t+1 and a migration probability θ_{i j} from the area i to the area j. The likelihood function L (M, θ) is maximized by alternating optimization related to M and θ.

### CITATION LIST

### Non Patent Literature

[NPL 1] D. R. Sheldon and T. G. Dietterich. Collective Graphical Models. In Proceedings of the 24th International Conference on Neural Information Processing Systems, pp. 1161-1169, 2011.
[NPL 2] T. Iwata, H. Shimizu, F. Naya, and N. Ueda. Estimating People Flow from Spatiotemporal Population Data via Collective Graphical Mixture Models. ACM Transactions on Spatial Algorithms and Systems, Vol. 3, No. 1, pp. 1-18, May 2017.

### SUMMARY OF THE INVENTION

### Technical Problem

According to the conventional technique, the maximization with respect to Mₜᵢⱼ as one step of alternating optimization is carried out by relaxing an integer variable into a continuous variable and using an optimization method with respect to the continuous variable under a conservation constraint about the number of people.

However, such an estimation method may lower the estimation accuracy. This is due to the following three phenomena.

Firstly, since the original probability model is defined by a multinomial distribution, the likelihood is meaningful only when the human migration number M is an integer, and the likelihood cannot be given any probabilistic meaning for the continuous relaxation. Therefore, the maximum likelihood estimation can be performed only in an approximate manner.

Secondly, while the following Stirling's approximation is used in the likelihood calculation, the approximation is inaccurate when Mₜᵢⱼ is small.

$$log {M}_{tij} ! \approx {M}_{tig} log {M}_{tij} - {M}_{tij}$$

In particular, when there are many destination candidates, for example when the area size is small, the accuracy of the approximation is reduced because the value of Mₜᵢⱼ is likely to be small.

Thirdly, the human migration number should be an integer, but the output could be a value having a decimal, which is improbable. The data may be rounded off to an integer value, but this greatly disrupts the conservation constraint about the number of people.

In particular, these phenomena are more pronounced when the area size is smaller and there are more areas as destination candidates.

The present invention is directed to a solution to the problem, and it is an object of the present invention to provide an integer human migration number estimating device, a method, and a program which allow a human migration number to be accurately estimated as an integer value without depending on the size of the area.

### Means for Solving the Problem

In order to achieve the object, an integer human migration number estimating device according to a first aspect of the invention includes an integer human migration number estimating unit which estimates a human migration number between areas at each time on the basis of the population of each of the areas at said each time under a constraint that the population of each of the areas at each time and the human migration number between the areas at said each time are in a predetermined relation and that the human migration number between the areas at said each time is an integer value in order to maximize a likelihood function expressed using the population of each of the areas at each time, the human migration number between the areas at said each time, and a migration probability between the areas, a migration probability estimating unit which estimates the migration probability between the areas on the basis of the estimated human migration number between the areas at said each time in order to maximize the likelihood function, and an estimation control unit which repeats the processing by the integer human migration number estimating unit and the migration probability estimating unit until a predetermined condition is satisfied.

A method for estimating an integer human migration number according to a second aspect of the invention includes estimating a human migration number between areas at each time by the integer human migration number estimating unit on the basis of the population of each of the areas at said each time under a constraint that the population of each of the areas at each time and the human migration number between the areas at said each time are in a predetermined relation and that the human migration number between the areas at said each time is an integer value in order to maximize a likelihood function expressed using the population of each of the areas at each time, the human migration number between the areas at said each time, and a migration probability between the areas, estimating the migration probability between the areas by the migration probability estimating unit on the basis of the estimated human migration number between the areas at said each time in order to maximize the likelihood function, and repeating, by the estimation control unit, the processing by the integer human migration number estimating unit and the migration probability estimating unit until a predetermined condition is satisfied.

A program according to a third aspect of the invention is a program for causing a computer to function as elements of the integer human migration number estimating device according to the first aspect of the invention.

### Effects of the Invention

According to the integer migration number estimating device, the method, and the program according to the invention, the processing includes the step of estimating a human migration number between areas at each time on the basis of the population of each of the areas at the time under a constraint that the population of each of areas at each time and the human migration number between the areas at the time are in a predetermined relation and that the human migration number between the areas at the time is an integer value in order to maximize a likelihood function expressed using the population of each of areas at each time, the human migration number between the areas at the time, and the migration probability between the areas and the step of estimating the migration probability between the areas on the basis of the estimated human migration number between the areas at the time in order to maximize the likelihood function, and the processing is repeated until a predetermined condition is satisfied, so that the human migration number can be estimated as an integer value with high accuracy without depending on the size of the area.

### BRIEF DESCRIPTION OF DRAWINGS

FIG. 1 is a block diagram of the configuration of an integer human migration number estimating device according to an embodiment of the present invention.

FIG. 2 is a table for illustrating an exemplary demographic information storing unit.

FIG. 3 is a table for illustrating an exemplary integer human migration number storing unit.

FIG. 4 is a table for illustrating an exemplary migration probability storing unit.

FIG. 5 is a flowchart for illustrating an integer human migration number estimating processing routine in the integer human migration number estimating device according to the embodiment of the present invention.

### DESCRIPTION OF EMBODIMENTS

Hereinafter, an embodiment of the present invention will be described with reference to the drawings.

<Configuration of Integer Human Migration Number Estimating Device according to Embodiment of Invention>

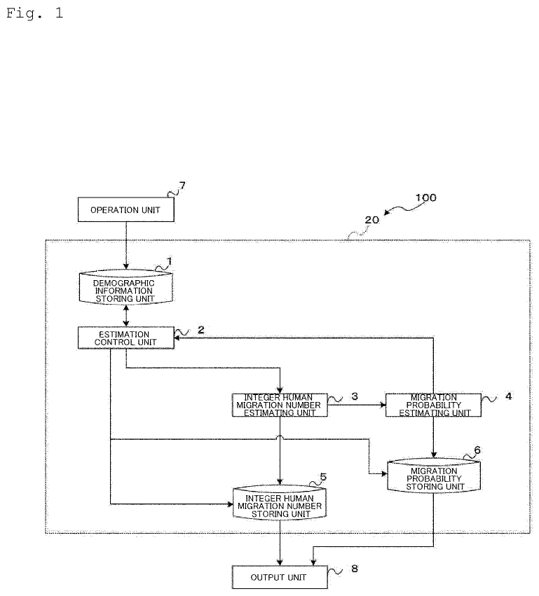

Now, the configuration of an integer human migration number estimating device according to the embodiment of the present invention will be described. As shown in FIG. 1, the integer human migration number estimating device 100 according to the embodiment of the present invention can be implemented by a computer including a CPU, a RAM, and a ROM which stores programs for executing an estimation processing routine which will be described and various kinds of data. As shown in FIG. 1, the integer human migration number estimating device 100 functionally includes an operation unit 7, an arithmetic unit 20, and an output unit 8.

The operation unit 7 accepts various kinds of operation to data from a demographic information storing unit 1. The various kinds of operation include registering, correcting, or deleting demographic information.

The arithmetic unit 20 includes the demographic information storing unit 1, an estimation control unit 2, an integer human migration number estimating unit 3, a migration probability estimating unit 4, an integer human migration number storing unit 5, and a migration probability storing unit 6.

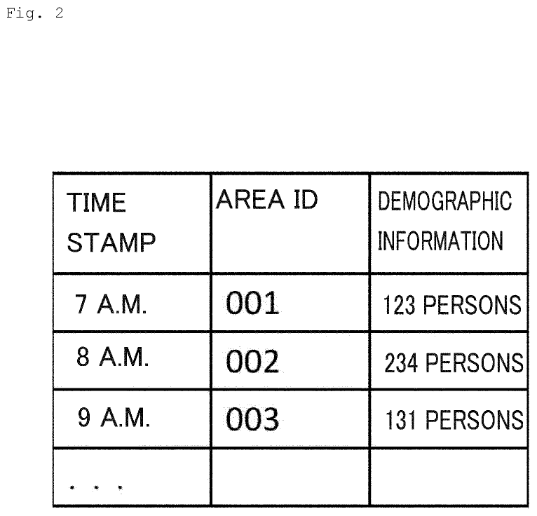

The demographic information storing unit 1 stores demographic information, reads out the demographic information in response to a request from the operation unit 7 and transfers the information to the estimation control unit 2. The demographic information is demographic information about each area in each time step. The time step is for example an o'clock time such as seven, eight, and nine in the morning, and the area is obtained for example by dividing a geographic space into a regular square grid having a cell size of 5 km. The population of an area i at time t is represented by Nₜᵢ. An example of data on stored demographic information is given in FIG. 2.

The outline of the estimating process will be described before describing various processing units.

The symbols for use in estimation are defined as follows.
V: The set of all the areas.
T: A maximum value for the time step, or the time step t=0, . . . , T−1.
G=(V, E) : An undirected graph representing the closeness between areas.
Tᵢ: A set of migration candidate areas from the area i. The population of the area i at the time t: Nₜᵢ(t=0, . . . , T−1, i ∈ V)
The human migration number from the area i to the area j from the time t to the time t+1: Mₜᵢⱼ(t=0, . . . , T−2, i,j ∈ V)

The migration probability from the area i to the area j is θᵢⱼ, and the human migration number Mₜᵢ from the area i at the time t is represented as Mₜᵢ={Mₜᵢⱼ|j ∈ V}. Then, it is assumed that Mₜᵢ can be produced with the probability indicated by the expression (1) using the following migration probability from the area i.

$${θ}_{i} = \{ {θ}_{ij} \vert j ∈ {Γ}_{i} \}$$

$$\begin{matrix}[ Formula 1 ] & \\ P ( {M}_{ti} \vert {N}_{ti} , {θ}_{i} ) = \frac{{N}_{ti} !}{{\prod }_{j ∈ {Γ}_{i}} {M}_{tij} !} {\prod }_{j ∈ {Γ}_{i}} {θ}_{ij}^{{M}_{tij}} & ( 1 )\end{matrix}$$

Therefore, when N={Nₜᵢ|t=0, . . . T−1, i ∈ V}, θ={θᵢ|i ∈ V}, the likelihood function of M={Mₜᵢ|t=0, . . . , T−2, i ∈ V} is given by the following expression (2).

$$\begin{matrix}[ Formula 2 ] & \\ P ( M \vert N , θ ) = {\prod }_{t = 0}^{T - 2} {\prod }_{i ϵ V} ( \frac{{N}_{ti} !}{{\prod }_{j ∈ {Γ}_{i}} {M}_{tij} !} {\prod }_{j ∈ {Γ}_{i}} {θ}_{ij}^{{M}_{tij}} ) & ( 2 )\end{matrix}$$

A constraint representing the law of conservation of the number of people is established by the following expressions (3) and (4).

$$\begin{matrix}[ Formula 3 ] & \\ {N}_{ti} = {\sum }_{j ∈ {Γ}_{i}} {M}_{tij} ( t = 0 , 1 , … , T - 2 ) & ( 3 ) \\ {N}_{t + 1 , i} = {\sum }_{j ∈ {Γ}_{i}} {M}_{tij} ( t = 0 , 1 , … , T - 2 ) & ( 4 )\end{matrix}$$

The estimation is performed by maximizing the likelihood function P(M|N, θ) according to the expressions (3) and (4) as the constraint. More specifically, the optimization problems to be solved are the following expressions (5a) to (5f).

$$[ Formula 4 ]$$

$$\begin{matrix}{maximize}_{M , θ} P ( M \vert N , θ ) & ( 5 a ) \\ subject to {N}_{ti} = {\sum }_{j ∈ {Γ}_{i}} {M}_{tij} ( t = 0 , 1 , … , T - 2 ) , & ( 5 b ) \\ {N}_{t + 1 , i} = {\sum }_{j ∈ {Γ}_{i}} {M}_{tji} ( t = 0 , 1 , … , T - 2 ) & ( 5 c ) \\ {\sum }_{j ∈ {Γ}_{i}} {θ}_{ij} = 1 ( i ∈ V ) & ( 5 d ) \\ 0 \leq {θ}_{ij} \leq 1 ( i , j ∈ V ) & ( 5 e ) \\ {M}_{tij} ∈ {ℤ}_{> 0} & ( 5 f )\end{matrix}$$

provided that

$${ℤ}_{> 0}$$

is the set of all the integers.

There maybe several methods for solving the optimization problems, and according to the embodiment, the problems are solved by the stochastic EM method (see NPL 4) which uses the Metropolis-Hastings method (see NPL 3). According to the method, M can be held and estimated as an integer value.

[NPL 3] W. K. Hastings. Monte Carlo Sampling Methods Using Markov Chains and Their Applications. Biometrika, Volume 57, Number 1(1970), pp. 97-109

[NPL 4] S. F. Nielsen. The Stochastic EM Algorithm: Estimation and Asymptotic Results. Bernoulli, Volume 6, Number 3(2000), pp. 457-489

More specifically, M and θ are updated by repeating the following E and M steps.

First, the E step (updating of M) will be described.

In the E step, M is updated by sampling M similarly to a general stochastic EM algorithm. Updating is carried out separately for each Mₜ. Note that Mₜ refers to an estimated human migration number from the time t to the time t+1. The Metropolis-Hastings method is used as the sampling method. The set of all Mₜ that satisfy the following constraint is represented by Fₜ.

$${N}_{ti} = {\sum }_{j ∈ {Γ}_{i}} {M}_{tij} ( i ∈ V ) , \\ {N}_{t + 1 , i} = {\sum }_{j ∈ {Γ}_{i}} {M}_{tji} ( j ∈ V ) , \\ {M}_{tij} ∈ {ℤ}_{> 0} ( i , j ∈ V )$$

A specific algorithm for updating Mₜ carries out the following processing steps 1 to 5. The algorithm is a method based on the Metropolis Hastings method.

1. Mₜ is initialized by an appropriate M^{init}ₜ ∈ Fₜ. (M^{init}ₜ can be found for example by linear programming.)
2. In order to prevent samples from overlapping, iₜ and i₂ are sampled from V without replacement. Also, i₃ and i₄ are sampled from V without replacement.
3. The result of adding 1 to

$${M}_{{ti}_{1} {i}_{3}} , {M}_{{ti}_{2} {i}_{4}}$$

or adding −1 to

$${M}_{{ti}_{1} {i}_{4}} , {M}_{{ti}_{2} {i}_{3}}$$

### is M′ₜ.

4. If

$${M}_{t}^{′} ∉ ℱ$$

holds, the process directly proceeds to 5. If

$${M}_{t}^{′} ∈ ℱ$$

holds, updating is carried out as

$${M}_{t} ← {M}_{t}^{′}$$

with the probability represented by

$$min ( 1 , \frac{P ( {M}_{t}^{′} \vert N , θ )}{P ( {M}_{t} \vert N , θ )} )$$

and no processing is carried out with the probability represented by

$$1 - min ( 1 , \frac{P ( {M}_{t}^{′} \vert N , θ )}{P ( {M}_{t} \vert N , θ )} )$$

5. The steps 2 to 4 are repeated. After the steps are repeated an appropriate number of times, Mₜ is output.

It can be indicated that by repeating the steps a sufficient number of times, M produced by the algorithm can be a result of approximate sampling from P(M|N, θ).

Now, the M step (updating of θ) will be described.

The following expression (6) results by taking the logarithm of the likelihood function P(M|N, θ).

$$[ Formula 5 ]$$

$$\begin{matrix}log P ( M \vert N , θ ) = & {\sum }_{t = 0}^{T - 2} {\sum }_{i ∈ V} ( log {N}_{ti} I - {\sum }_{j ∈ {Γ}_{i}} log {M}_{tij} I + \\ & {\sum }_{j ∈ {Γ}_{i}} {M}_{tij} log {θ}_{ij} ) \\ = & {\sum }_{t = 0}^{T - 2} {\sum }_{i ∈ V} {\sum }_{j ∈ {Γ}_{i}} {M}_{tij} log {θ}_{ij} + const .\end{matrix} \qquad ( 6 )$$

In the last line in the above expression, the part other than those depending on θ is omitted as a constant. Log P(M|N, θ) may be maximized under the constraint represented by the following expression.

$${Σ}_{j ∈ {Γ}_{i}} {θ}_{ij} = 1 ( i ∈ V ) , 0 \leq {θ}_{ij} \leq 1 ( i , j ∈ V )$$

Using the Lagrange's undefined multiplier method, such θ*can be described in a closed form as in the following expression (7).

$$[ Formula 6 ]$$

$${θ}_{ij}^{*} = \frac{{\sum }_{t = 0}^{T - 2} {M}_{tij}}{{\sum }_{t = 0}^{T - 2} {Σ}_{k ∈ {Γ}_{i}} {M}_{tik}} \qquad ( 7 )$$

The foregoing is the outline of the estimation process.

The processing by the various processing units will be described in consideration of the above estimation process.

The estimation control unit 2 reads out demographic information from the demographic information storing unit 1 and transfers the information to the integer human migration number estimating unit 3 to start the estimation process. The estimation control unit 2 determines whether the condition is satisfied each time execution by the migration probability estimating unit 4 is completed to check whether or not to end the estimation and repeats the processing by the integer human migration number estimating unit 3 and the migration probability estimating unit 4. As the method for determining whether the condition is satisfied, whether the likelihood converges may be checked or the process may end when a specified number of repetition ends. When the estimation ends, the estimation control unit 2 transmits the estimated integer human migration number and the migration probability to the integer human migration number storing unit 5 and the migration probability storing unit 6, respectively.

The integer human migration number estimating unit 3 estimates the human migration number M between areas of demographic information at each time on the basis of the population of the area at the time under the constraint indicated by the expressions (5b) to (5f) that the population of each of the areas at each time and the human migration number between the areas at the time are in a predetermined relation and that the human migration number between areas at each time is an integer value in order to maximize the likelihood function represented by the expression (2) using the population Nₜᵢof each of the areas at each time, the human migration number Mₜᵢ between areas at each time, and the migration probability θᵢⱼ between the area. Specifically, the estimation is carried out by sampling a human migration number between areas at each time which satisfies the constraint indicated by the expressions (5b) to (5f) on the basis of a migration probability between the areas estimated by the migration probability estimating unit 4 according to the algorithm using the Metropolis Hastings method described in relation to the E step, and the likelihood function represented by the expression (2).

The migration probability estimating unit 4 estimates the migration probability between the areas on the basis of the estimated human migration number M between the areas at each time in order to maximize the likelihood function represented by the expression (2). Specifically, as described in relation to the M step, the migration probability θ is estimated according to the expression (7).

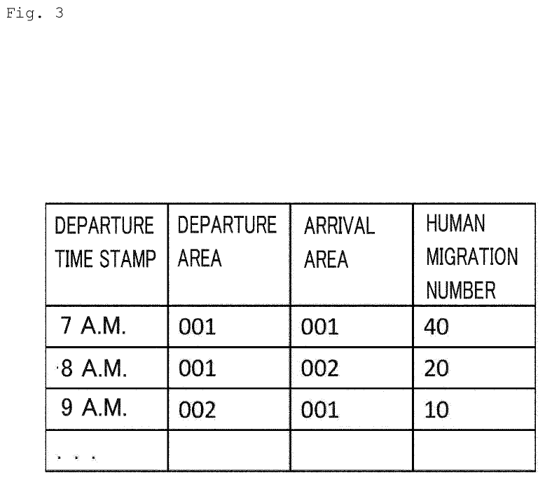

The integer human migration number storing unit 5 stores the estimated human migration number M. The integer human migration number storing unit 5 stores records of a departure time stamp, a departure area, an arrival area, and a human migration number for example as shown in FIG. 3.

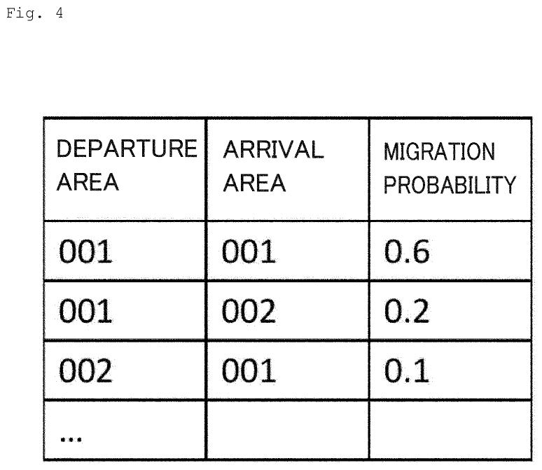

The migration probability storing unit 6 stores the estimated migration probability θ. The migration probability storing unit 6 stores records of a departure area, an arrival area, and a migration probability for example as shown in FIG. 4.

The output unit 8 reads the human migration number M between areas between time steps stored in the integer human migration number storing unit 5 and the migration probability θ between the areas stored in the migration probability storing unit 6 and outputs the data.

<Operation of Integer Human Migration Number Estimating Device according to Embodiment of Invention>

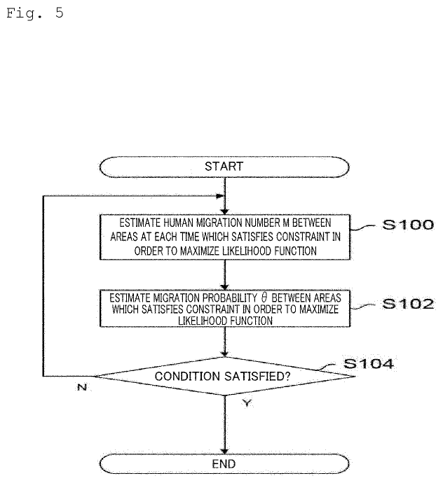

Now, the operation of the integer human migration number estimating device 100 according to the embodiment of the present invention will be described. The integer human migration number estimating device 100 executes the integer human migration number estimating processing routine shown in FIG. 5 as the estimation control unit 2 starts the estimation process by reading out demographic information from the demographic information storing unit 1 and transferring the information to the integer human migration number estimating unit 3.

To start with, in the step S100, the integer human migration number estimating unit 3 estimates the human migration number M between areas in demographic information at each time on the basis of the population of each of the areas at each time under the constraint indicated by the expressions (5b) to (5f) that the population of each of the areas at each time and the human migration number between the areas at the time are in a predetermined relation and that the human migration number between the areas at the time is an integer value in order to maximize the likelihood function represented by the expression (2) using the population Nₜᵢ of each of the areas at each time, the human migration number Mₜᵢ between the areas at the time and the migration probability θᵢⱼ between the areas. Specifically, the estimation is carried out by sampling the human migration number between areas at each time which satisfies the constraint of the expressions (5b) to (5f).

Then, in step S102, the migration probability estimating unit 4 estimates the migration probability θ between the areas according to the expression (7) on the basis of the human migration number M between the areas at each time estimated in step S100 in order to maximize the likelihood function represented by the expression (2). Specifically, the migration probability θ is estimated by the method described in relation to the M step.

In step S104, the estimation control unit 2 determines whether the condition is satisfied, and the processing ends if the condition is satisfied, and the processing in steps S100 and S102 is repeated if not.

As in the foregoing, the integer human migration number estimating device according to the embodiment of the present invention estimates a human migration number between areas at each time on the basis of the population of each of the areas at the time under the constraint that the population of each of the areas at each time and a human migration number between the areas are in a predetermined relation and that the human migration number between the areas at each time is an integer value in order to maximize the likelihood function expressed using the population of each of the areas at each time, the human migration number between the areas at the time, and the migration probability between the areas, and the migration probability between the areas on the basis of the estimated human migration number between the areas at the time in order to maximize the likelihood function, and the processing is repeated until a predetermined condition is satisfied, so that the human migration number can be estimated as an integer number with high accuracy without depending on the area size.

<Modification>

A modification of the embodiment will be described.

According to the modification, the processing by the integer human migration number estimating unit 3 according to the embodiment is formulated as a constrained transportation problem and an algorithm for the transportation problem is applied rather than carrying out the sampling-based method.

Only the part related to the processing by the integer human migration number estimating unit 3 of the integer human migration number estimating device 100 is modified while the other features and functions are unchanged, and therefore only the modified part of the integer human migration number estimating unit 3 will be described.

The likelihood function in the integer human migration number estimating unit 3 is formulated as in the following expression (8).

$$[ Formula 7 ]$$

$$\begin{matrix}log P ( M \vert N , θ ) = & {\sum }_{t = 0}^{T - 2} {\sum }_{i ∈ V} ( log {N}_{ti} I - {\sum }_{j ∈ {Γ}_{i}} log {M}_{tij} I + \\ & {\sum }_{j ∈ {Γ}_{i}} {M}_{tij} log {θ}_{ij} ) \\ = & {\sum }_{t = 0}^{T - 3} {\sum }_{i ∈ V} {\sum }_{j ∈ {Γ}_{i}} ( - log {M}_{tij} I + \\ & {M}_{tij} log {θ}_{ij} ) + const .\end{matrix} \qquad ( 8 )$$

Note that the part unrelated to M is omitted as a constant. A human migration number between areas at each time which maximizes the likelihood function represented by the expression (8) and satisfies the constraint according to the following expressions (9b) to (9d) is estimated.

$$[ Formula 8 ]$$

$$\begin{matrix}{maximize}_{{M}_{i}} {\sum }_{i ∈ V} {\sum }_{j ∈ {Γ}_{i}} ( - log {M}_{tij} I + {M}_{tij} log {θ}_{ij} ) & ( 9 a ) \\ subject to {N}_{ti} = {\sum }_{j ∈ {Γ}_{i}} {M}_{tij} , & ( 9 b ) \\ {N}_{t + 1 , i} = {\sum }_{j ∈ {Γ}_{i}} {M}_{tji} & ( 9 c ) \\ {M}_{tij} ∈ {ℤ}_{> 0} & ( 9 d )\end{matrix}$$

The optimization problem is an example of an optimization problem generally referred to as a transportation problem (see NPL 5), and therefore an algorithm for a transportation problem can be applied. Since the objective function is not linear with respect to Mt, a global optimum solution may not be obtained but a solution with a sufficient quality may be obtained.

[NPL 5] G. B. Danzig. Application of the simplex method to a transportation problem. In T. C. Koopmans, editor, Activity Analysis of Production and Allocation, volume 13 of Cowles Commission for Research in Economics, pp. 359-373, Wiley, 1951.

The algorithm for the transportation problem is applied in the processing in the E step by the integer human migration number estimating unit 3, and the M step according to the embodiment is repeated, so that the integer human migration number estimating unit 3 can estimate a human migration number between areas at each time.

Note that the present invention is not limited by the embodiment, and various modifications and applications are available within the range without departing from the spirit and scope of the invention.

### REFERENCE SIGNS LIST

1 Demographic information storing unit
2. Estimation control unit
3 Integer human migration number estimating unit
4 Migration probability estimating unit
5 Integer human migration number storing unit
6 Migration probability storing unit
7 Operation unit
20 Arithmetic unit
100 Integer human migration number estimating device

1. A device for estimating an integral number of moving people, the device comprising:
an estimator of an integral number of moving people configured to estimate an integral number of people moving between areas at each time on the basis of the population of each of the areas at said each time under a constraint that the population of each of the areas at each time and a number of people moving between the areas at said each time are in a predetermined relation and that the human migration number of people moving between the areas at said each time is an integer value in order to maximize a likelihood function expressed using the population of each of the areas at each time, the number of people moving between the areas at said each time, and a migration probability between the areas;
a migration probability estimator configured to estimate the migration probability between the areas on the basis of the estimated number of moving people between the areas at said each time in order to maximize the likelihood function; and
an estimation controller configured to repeat the processing by the integral number of moving people estimator and the migration probability estimator until a predetermined condition is satisfied.

2. The device according to claim 1, wherein the estimator of an integral number of moving people samples the number of people moving between areas at each time which satisfies the constraint on the basis of the migration probability between the areas estimated by the migration probability estimator and the likelihood function.

3. The device according to claim 1, wherein the estimator of an integral number of moving people estimates the integral number of people moving between areas at each time which maximizes the likelihood function obtained by using the migration probability between the areas estimated by the migration probability estimator and satisfies the constraint.

4. A computer-implemented method for estimating an integral number of moving people, the method comprising:
estimating an integral number of people moving between areas at each time by an estimator of an integral number of moving people on the basis of a population of each of the areas at said each time under a constraint that the population of each of the areas at each time and the integral number of people moving between the areas at said each time are in a predetermined relation and the integral number of people moving between the areas at said each time is an integer value in order to maximize a likelihood function expressed using the population of each of the areas at each time, the integral number of people moving between the areas at said each time, and a migration probability between the areas;
estimating the migration probability between the areas by a migration probability estimator on the basis of the estimated integral number of moving people between the areas at said each time in order to maximize the likelihood function; and
repeating, by an estimation controller, the processing by the estimator of an integral number of moving people and the migration probability estimator until a predetermined condition is satisfied.

5. The computer-implemented method of claim 4, wherein the integral number of moving people estimator samples an integral number of people moving between areas at each time which satisfies the constraint on the basis of the migration probability between the areas estimated by the migration probability estimator and the likelihood function.

6. The computer-implemented method according to claim 4, wherein the estimator of an integral number of moving people estimates an integral number of people moving between areas at each time which maximizes the likelihood function obtained by using the migration probability between the areas estimated by the migration probability estimator and satisfies the constraint.

7. A program for causing a computer to function as elements of a device for estimating an integral number of moving people, the device comprising:
an estimator of an integral number of moving people configured to estimate an integral number of people moving between areas at each time on the basis of the population of each of the areas at said each time under a constraint that the population of each of the areas at each time and a number of people moving between the areas at said each time are in a predetermined relation and that the number of people moving between the areas at said each time is an integer value in order to maximize a likelihood function expressed using the population of each of the areas at each time, the number of people moving between the areas at said each time, and a migration probability between the areas;
a migration probability estimator configured to estimate the migration probability between the areas on the basis of the estimated number of moving people between the areas at said each time in order to maximize the likelihood function; and
an estimation controller configured to repeat the processing by the integral number of moving people estimator and the migration probability estimator until a predetermined condition is satisfied.

8. The device according to claim 1, the device further comprising:
the estimation controller configured to receive demographic information, wherein the demographic information includes an area and a number of people in the area at a time, wherein the number of people is an integral number.

9. The device according to claim 1, the device further comprising:
the estimator of an integral number of moving people configured to estimate the integral number of people moving between the areas using the Metropolis Hastings method.

10. The device according to claim 1, the device further comprising:
an output provider configured to provide a number of people moving between a first area and a second area at during a time period and a probability of people moving between the first area and the second area during the time period.

11. The device according to claim 1, wherein the estimator of an integral number of moving people estimates the number of people moving between the areas based on a transportation problem.

12. The computer-implemented method of claim 4, the method further comprising:
receiving demographic information, wherein the demographic information includes an area and a number of people in the area at a time, wherein the number of people is an integral number.

13. The computer-implemented method of claim 4, the method further comprising:
estimating the integral number of people moving between the areas using the Metropolis Hastings method.

14. The computer-implemented method of claim 4, the method further comprising:
providing a number of people moving between a first area and a second area at during a time period and a probability of people moving between the first area and the second area during the time period.

15. The computer-implemented method of claim 4, wherein the estimator of an integral number of moving people estimates the number of people moving between a first area and a second area based on a transportation problem, wherein the first area and the second area are distinct.

16. The program for causing the computer to function as elements of the device of claim 7, wherein the estimator of an integral number of moving people samples the number of people moving between areas at each time which satisfies the constraint on the basis of the migration probability between the areas estimated by the migration probability estimator and the likelihood function.

17. The program for causing the computer to function as elements of the device of claim 7, wherein the estimator of an integral number of moving people estimates the integral number of people moving between areas at each time which maximizes the likelihood function obtained by using the migration probability between the areas estimated by the migration probability estimator and satisfies the constraint.

18. The program for causing the computer to function as elements of the device of claim 7, the device further comprising:
the estimation controller configured to receive demographic information, wherein the demographic information includes an area and a number of people in the area at a time, wherein the number of people is an integral number.

19. The program for causing the computer to function as elements of the device of claim 7, the device further comprising:
the estimator of an integral number of moving people configured to estimate the integral number of people moving between the areas using the Metropolis Hastings method.

20. The program for causing the computer to function as elements of the device of claim 7, the device further comprising:
an output provider configured to provide a number of people moving between a first area and a second area at during a time period and a probability of people moving between the first area and the second area during the time period.
